(19) United States
(12) Patent Application Publication
(10) Pub. No.: US 2012/0261020 A1
(43) Pub. Date: Oct. 18, 2012

(54) METHOD FOR PRODUCING A PROTECTIVE COATING ON A TUBE, AND TUBE COMPRISING A COATING OBTAINED BY MEANS OF SUCH A METHOD

(75) Inventor: Bernard Cavalie, dunkerque (FR)

(73) Assignee: EUPEC PIPECOATINGS FRANCE, Gravelines (FR)

(21) Appl. No.: 13/505,593

(22) PCT Filed: Nov. 2, 2010
(86) PCT No.: PCT/FR10/52346

§ 371 Date: Jul. 5, 2012

(30) Foreign Application Priority Data
Nov. 2, 2009 (FR) 0957722

(51) Int. Cl. F16L 9/14

(52) U.S. Cl. 138/141

(57) ABSTRACT

A method includes: moving the tube (1) in a longitudinal translation movement and simultaneously in rotation; heating the tube (1); depositing a layer of epoxy powder (9) on the outer surface of the tube (1); winding at least one strip of an adhesive material in paste form onto the epoxy layer (9); winding at least one strip of polypropylene in paste form onto the strip of adhesive material (11) such as to form a polypropylene layer (16); cooling the assembly thus obtained; heating the skin of the layer of polypropylene (16) and winding on at least one strip of non-compressible, thermally insulating elastomer in paste form such as to form an elastomer layer (22).

The object of the present invention is a method for producing a protective coating on a tube, and notably on a pipeline tube which may be immersed.

Pipeline tubes are generally used for conveying hydrocarbons and it is important that the temperature of the conveyed products does not reach a lower limiting temperature below which large deposits are formed in the tubes.

Moreover, when they are operating, the tubes are in permanent contact with sea water. Therefore there is a significant risk of corrosion of the tube, so that the chemical properties of the coating are also very important.

Consequently, the tubes have to be coated with an insulating envelope in order to maintain the conveyed hydrocarbons at the desired temperature in order to avoid clogging phenomena. Indeed, if the tubes are not sufficiently insulated, a wax deposit or a hydrate deposit may form inside these tubes, which slows down the flow rate and gradually blocks the tubes.

The insulating envelope should therefore be sufficiently dimensioned so as to avoid these phenomena.

Generally, the sea water in which the tubes are laid is colder when the depth increases, the quality of the insulating coating and its behavior are therefore extremely important.

Particular problems are posed when the pipeline tubes are laid in a deep or very deep sea, which corresponds to depths beyond about 3 000 meters. Indeed, when the depth increases, the temperature of the water decreases. Therefore in order to maintain the desired temperature of the tube, the coating should have more performing characteristics at great depths than when the tube is immersed at lower depths.

Moreover, at great depths, the tubes are subject to significant hydrostatic pressure, of more than 300 bars at a depth of more than 3 000 meters.

Therefore, the greater the depth, the greater the compressive strength of the material used for the coating should be.

It is known to coat pipeline tubes with an insulating formed from polypropylene foam. However, such an envelope has neither the insulating properties, nor the mechanical strength required at great depths.

Indeed, when they are subject to significant pressures, these foamed coatings are compressed which generates densification of the insulating layer and therefore an increase in its heat conductivity. Because of this compression and of the entry of the water into the cells of the foam, the heat conductivity of this material tends towards 0.22 W·m⁻¹·K⁻¹.

Finally, as polypropylene is a very stiff material, the risks of cracks and therefore of mechanical embrittlement are significant.

In order to improve the insulating properties of the polypropylene, loading this material with hollow glass microbeads is also known. However, this method also has drawbacks when the tubes are laid at great depths. Indeed, because of their making method, glass microbeads are not homogeneous as regards their resistance to pressure. The result of this is that at high operating pressures, a significant percentage of these microbeads is broken, which generates cracks in the insulating material. These cracks allow the passing of water and thereby lead to a reduction, not only in the mechanical properties of the material but also in its insulating properties.

The object of the present invention is to propose a method for obtaining a coating on a tube and notably on a pipeline tube, with which it is possible to get rid of the aforementioned drawbacks.

The object of the invention is therefore a method for producing a protective coating on a tube, notably on a pipeline tube which may be immersed, comprising the steps of:
displacing the tube in a longitudinal translational movement and simultaneously driving said tube in rotation,
heating the tube to a temperature comprised between 160° C. and 230° C., and preferably between 180° C. and 220° C.,
forming from an epoxy powder an epoxy layer on the outer surface of the tube,
winding at least one adhesive strip in paste form onto the epoxy layer in order form an adhesive layer,
winding at least one polypropylene strip in paste form onto said adhesive layer in order to obtain a first polypropylene layer,
   characterizing that it also comprises the steps of:
cooling the thereby obtained assembly down to a temperature of the order of 80° C.,
heating the skin of said first polypropylene layer up to a temperature of at least 110° C.,
winding at least one strip of incompressible heat insulating elastomer in paste form in order to form a first elastomer layer.

According to other features of the invention:
after having formed said first elastomer layer,
   the obtained assembly is cooled down to a temperature of the order of 80° C.,
   the skin of the first applied elastomer layer is heated up to a temperature of at least 110° C., and
   at least one polypropylene strip in paste form is deposited on said first elastomer layer in order to form a second polypropylene layer,
after having formed the second polypropylene layer,
   the obtained assembly is cooled down to a temperature down to the order of 80° C.,
   the skin of the second polypropylene layer is heated up to a temperature of at least 110° C., and
   at least one strip of said elastomer in paste form is deposited on said polypropylene layer in order to form a second elastomer layer.
said elastomer has a heat conductivity of less than 0.15 W·m⁻¹·K⁻¹,
said elastomer comprises at least one crosslinkable elastomer selected from butyl rubber, halobutyls and brominated copolymers of isobutylene and of para-methylstyrene and at least one non-crosslinkable elastomer of low heat conductivity,
the epoxy powder is deposited by electrostatic spraying and said powder is agglomerated by melting,
the epoxy layer has a thickness comprised between 10 and 800 micrometers,
the adhesive layer has a thickness comprised between 10 and 1 000 micrometers and preferably comprised between 300 and 600 micrometers,
said strips of said first and second elastomer layers or said strips of said first or second polypropylene layers or said strips of said adhesive layer are obtained by lateral extrusion relatively to the displacement direction of the tube,
said strips of said first or second elastomer layers or said strips of said first or second polypropylene layers or said strips of said adhesive layer are obtained by longitudinal extrusion relatively to the displacement direction of the tube,
said strips of said first or second elastomer layers or said strips of said first or second polypropylene layers or said strips of said adhesive layer are obtained by co-extrusion,
said strips of said first or second elastomer layers are subject to pressure by means of a pressure roll,
each of said strips of said first elastomer layer has a thickness comprised between 2 and 30 mm.
said strips of said first or second elastomer layers are extruded at a temperature comprised between 140° C. and 230° C. and preferably between 180° C. and 200° C.

The invention also relates to a tube including a coating made according to the method defined above, characterizing that it successively includes an epoxy layer, an adhesive layer, a first polypropylene layer and a first elastomer layer. According to other features of the invention:
the tube further includes above the first elastomer layer a second polypropylene layer,
the tube further includes above the second polymer layer a second elastomer layer.

The invention will be better understood by means of the description which follows, only given as an example and made with reference to the indexed drawings, wherein:

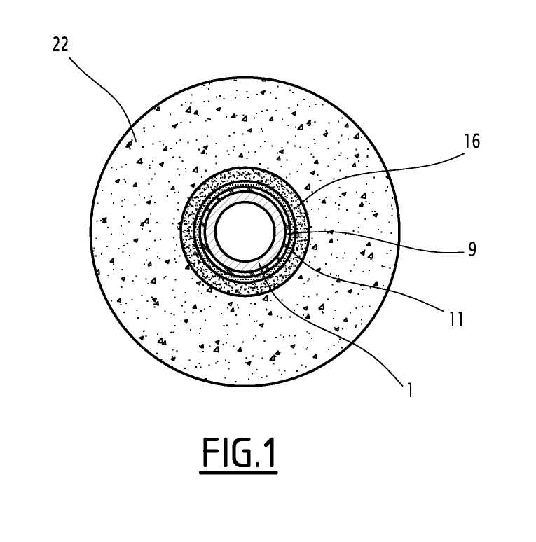

FIG. 1 is a cross-sectional view of a tube coated with a coating according to a first embodiment of the invention,

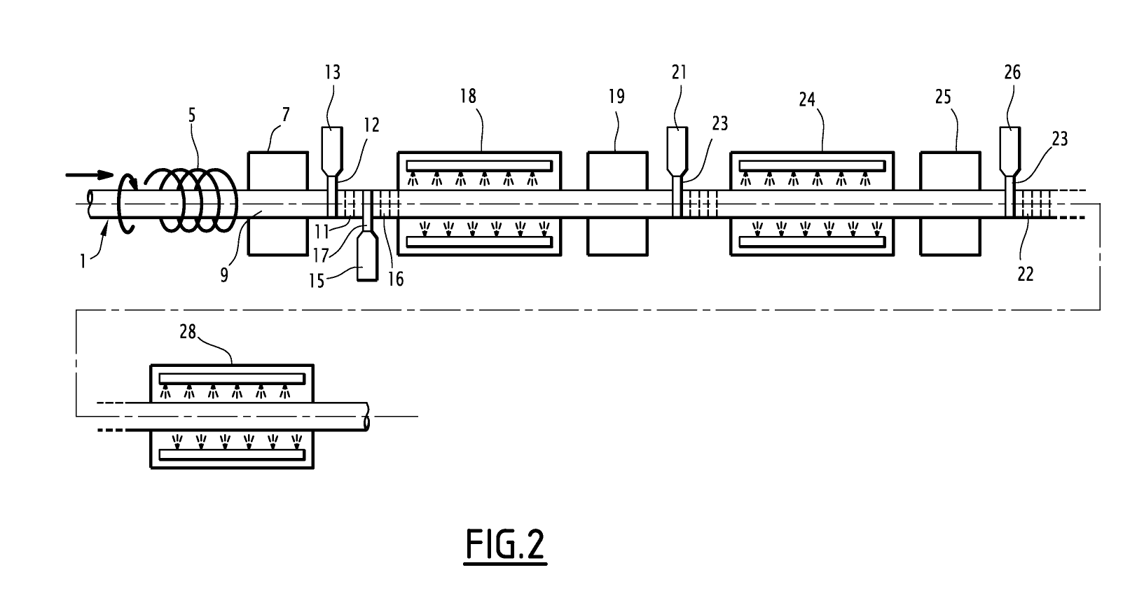

FIG. 2 is a schematic view of an installation for applying the method according to a first embodiment of the invention,

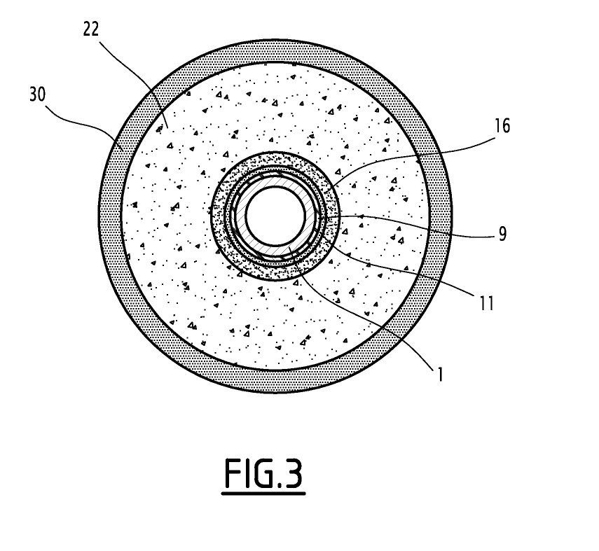

FIG. 3 is a cross-sectional view of a tube coated with a coating according to a second embodiment of the invention,

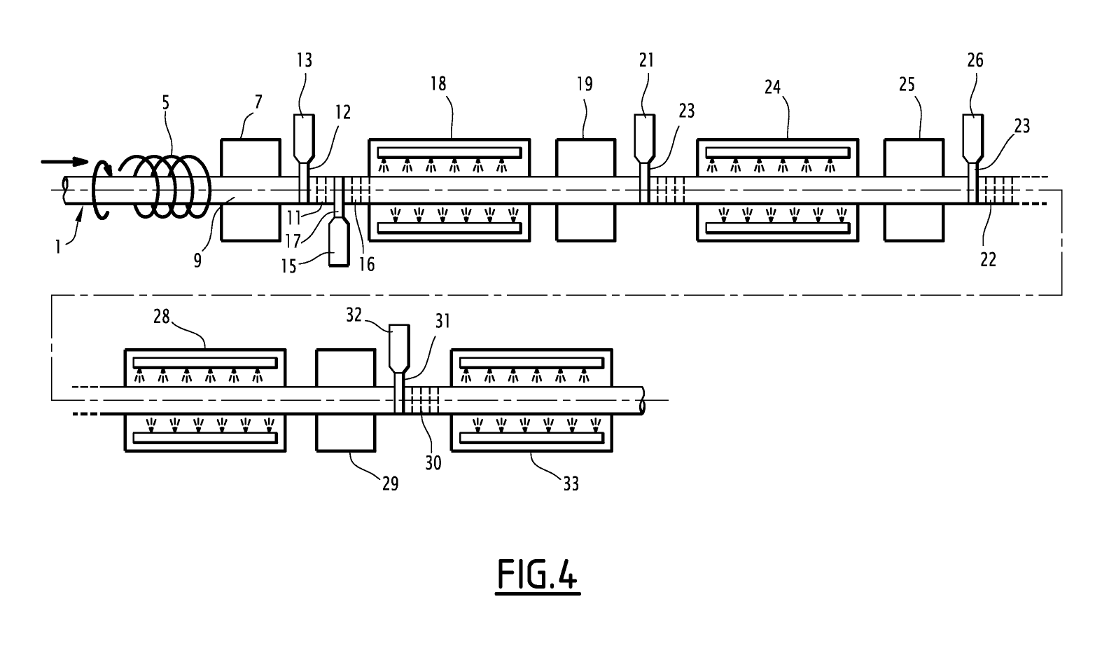

FIG. 4 is a schematic view of an installation for applying the method according to a second embodiment of the invention,

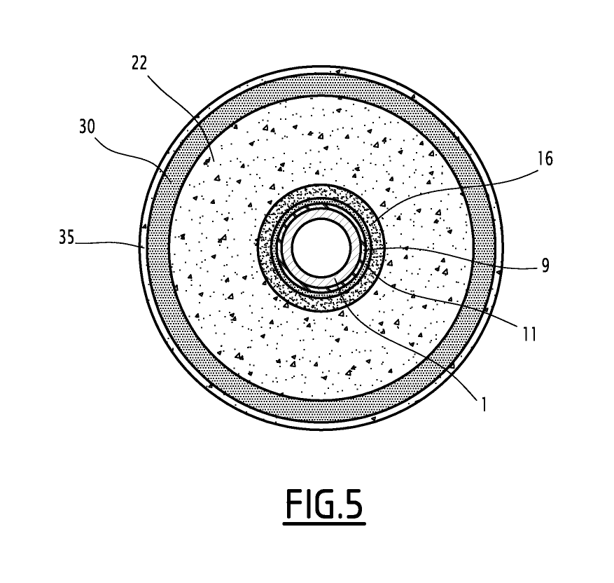

FIG. 5 is a cross-sectional view of a tube coated with a coating according to a third embodiment of the invention, and

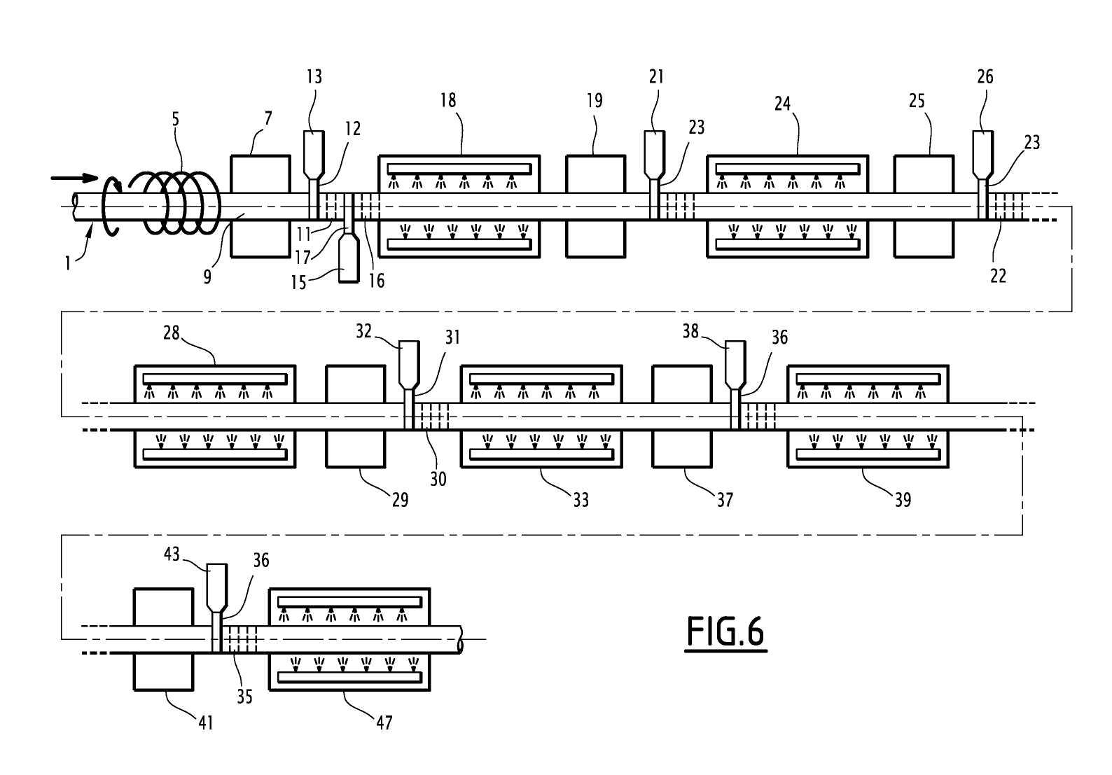

FIG. 6 is a schematic view of an installation for applying the method according to a third embodiment of the invention.

According to a first embodiment of the tube including the coating according to the invention, illustrated in FIG. 1, the tube 1, which for example is a pipeline tube intended to be immersed at depths beyond 3 000 m, is successively coated
with an epoxy layer 9,
with an adhesive layer 11, consisting of at least one adhesive strip 12,
a polypropylene layer 16, consisting of at least one polypropylene strip 17, and
with an elastomer layer 22, consisting of at least one elastomer strip 23.

According to the first embodiment, the epoxy layer 9 has a thickness preferably comprised between 10 and 800 micrometers and preferably between 150 and 300 micrometers; the adhesive layer 11 for example has a thickness comprised between 10 and 1 000 micrometers and preferably comprised between 300 and 600 micrometers; the polypropylene layer 16 for example has a thickness comprised between 1 mm and 20 mm and preferably between 3 mm and 5 mm and the elastomer layer 22 has a thickness preferably comprised between 2 mm and 150 mm, each of the applied elastomer strips 23 for example having a thickness comprised between 2 and 30 mm.

The method according to the invention gives the possibility of producing a protective coating on a tube 1, and notably on a pipeline tube intended to be immersed at depths beyond 3 000 m.

During the different steps to the method, the tube 1 is displaced in a longitudinal translational movement and simultaneously driven into rotation in an installation 3, at an angular velocity allowing an advance comprised between 1 cm and 20 cm at each rotation of the tube 1 and at a peripheral rotational velocity of the tube 1 preferably comprised between 10 and 50 m/min for an average diameter of the tube 1 comprised between 25 mm and 1 500 mm.

FIG. 2 shows the installation 3 which allows application of the method which results in the tube 1 including the coating according to the first embodiment of the invention.

The tube 1 is first heated via heating means 5 up to a temperature comprised between 160° C. and 230° C. and preferably comprised between 180° C. and 220° C. These heating means are for example at least one induction heating ring or any other suitable heating means.

Next, an epoxy powder is deposited by electrostatic spraying on the outer surface of the hot tube 1 for example by means of a spraying box 7. This epoxy powder adheres onto the hot surface of the tube 1 by an electrostatic effect and melts in contact with the hot tube 1 so as to form a homogeneous epoxy layer 9 on the tube 1.

The epoxy layer 9 has a thickness preferably comprised between 10 and 800 micrometers.

At least one strip 12 of an adhesive in paste form is then wound onto the epoxy layer 9 and before the cooling of this epoxy layer 9, in order to form an adhesive layer 11 by means of an extrusion machine 13.

Said at least one adhesive strip 12 may be applied by lateral extrusion relatively to the displacement direction of the tube 1, by longitudinal extrusion or by co-extrusion.

According to another embodiment of the invention, the adhesive layer 11 may also be applied by continuous spraying from an adhesive powder.

The adhesive layer 11 has a thickness comprised between 10 and 1 000 micrometers and preferably comprised between 300 and 600 micrometers.

The adhesive material for example comprises by weight:
from 59 to 94% of polypropylene or a propylene/ethylene or propylene/ethylene/butene 1 random copolymer or further their mixtures with one or more plastomeric polymers selected from ethylene/vinyl/vinyl acetate copolymers, LDPE, HDPE, polyamide polyurethane,
from 5 to 40% of a polymer or a mixture of elastomeric polymers selected from EPR, EPDM, SEBS and SBS block copolymers, and ethylene/ethyl acrylate copolymers,
from 1 to 10% of polypropylene modified with maleic anhydride or isophorone bis-maleic acid for the acrylic acid.

Simultaneously with the winding of said at least one adhesive strip 12, at least one polypropylene strip 17 in paste form is wound onto the adhesive layer 11 via means of an extrusion machine 15 for obtaining a polypropylene layer 16. Several extrusion machines 15 may be positioned side by side so as to deposit several polypropylene strips 17 onto each other in order to form the polypropylene layer 16.

Said at least one polypropylene strip 17 may be applied by lateral extrusion relatively to the displacement direction of the tube 1, by longitudinal extrusion or by co-extrusion.

The polypropylene layer 16 has a thickness preferably comprised between 1 mm and 20 mm and preferably between 3 mm and 5 mm.

The polypropylene used for forming the polypropylene strips 17 comprises 92 to 100% by weight of a thermoplastic polymer selected from a crystalline co-polymer of polypropylene containing 2 to 25% by moles of ethylene and/or a C4-C10 alpha-olefin, heterophasic composition comprising a polymer of the type mentioned earlier and one or more elastomeric olefin co-polymers.

The polymers which may be used in this method are:
an isotactic polypropylene with an isotacticity index which may attain 99,
a propylene/ethylene random copolymer with an ethylene level varying from 1 to 6% by weight and preferably between 2 to 4% by weight,
a propylene/ethylene/1-butene random copolymer with a level of ethylene from 2% to 3% by weight and of 1-butene from 4.5 to 5.6% by weight.
a mixture of the aforementioned polymers with an EPR and EPDM elastomer, the EPR (ethylene propylene rubber) being optionally crosslinked and preferably containing from 5 to 40% by weight of elastomer,
heterophasic compositions obtained by stereospecific sequential polymerization of polypropylene with ethylene and/or a C4-C10 alpha-olefin, optionally in the presence of a small amount of 1-diene such as butadiene, 1,4-hexadiene, 1,5-hexadiene and ethylene norbornene-1.

Examples of a C4-C10 alpha olefin which may be present in the polymers mentioned earlier, are butene-1,4, methylpentene-1 and hexene-1.

In the heterophasic compositions, the ethylene and/or the alpha-olefins may be present in amounts up to 50% by weight.

The total thickness of the three layers 9, 11,16 is comprised between 1 mm and 30 mm and preferably between 3 mm and 6 mm.

Once the polypropylene layer 16 is deposited, the tube 1 coated with the already formed layers 9, 11, 16 is cooled by having it pass through a cooling tunnel 18, where it is sprayed for example with water and/or air in order to attain a temperature of the tube 1 of the order of 80° C.

At the end of this cooling step, the skin of the polypropylene layer 16 is heated at the surface via a suitable heating means 19, for example an infrared radiant heater, until a skin temperature of the polypropylene layer 16 of at least 110° C. is attained.

At least one elastomer strip 23 in paste form is then immediately wound onto the polypropylene layer 16 by means of an extrusion machine 21.

In order to form the elastomer layer 22, consisting of several elastomer strips 23, for each elastomer strip 23 to be applied, the tube 1 coated with the already formed layers 9, 11, 16 and with the already deposited elastomer strips 23 is first cooled by having it pass into a cooling tunnel 24, where it is sprayed with water and/or air until a temperature of the tube 1 of the order of 80° C. is attained.

The skin of the last elastomer strip 23 applied on the tube 1 is then heated at the surface via a suitable heating means 25, for example by a means of an infrared radiant heater, until a temperature of the skin of at least 110° C. is attained.

An elastomer strip 23 in paste form is then wound onto the last elastomer strip 23 applied by means of an extrusion machine 26. At the outlet of the extrusion machine 26, the temperature of the elastomer strip 23 is comprised between 140° C. and 230° C. and preferably between 180° C. and 200° C. During the winding of the strip 23, in order to allow the elastomer to adhere to itself, the elastomer strip 23 is subject to pressure of about 3 to 4 bars via a pressure application means of a known type, for example by means of a silicone roller with a shore A hardness 23.

This succession of operations is repeated until an elastomer layer 22 is obtained with the desired thickness. For this, as many blocks consisting of a cooling tunnel 24, a suitable heating means 25, for example an infrared radiant heater, an extrusion machine 26 and a pressure application means of a known type are placed side by side, as there are elastomer strips 23 which are desirably deposited in order to form an elastomer layer 22 with the desired thickness.

A thickness of the elastomer layer 22 for example comprised between 2 mm and 150 mm may thus be obtained, each of the applied strips 23 for example having a thickness comprised between 2 and 30 mm.

The elastomers which may be used in this method are heat-insulating incompressible elastomers and comprising at least one crosslinkable elastomer selected from the group formed by butyl rubber, halobutyls and brominated copolymers of isotbutylene and para-methylstyrene and at least one non-crosslinkable elastomer with low heat conductivity, for example with a heat conductivity of less than 0.15 W·m⁻¹·K⁻¹.

In this method, the elastomer strips 23 may be applied by lateral extrusion relatively to the displacement direction of the tube 1, by longitudinal extrusion or by co-extrusion.

In order to be able to apply the elastomer by extrusion, the fluidity of the elastomer is adjusted by adding a more fluid polymer.

All the steps may be carried out on a same coating line.

However, if a different coating line is used for applying the elastomer strips 23, the surface of the polypropylene layer 16 is cleaned with a solvent, in order to degrease it and remove all traces of contaminants or plasticizers, after passing of the tube 1 coated with the already formed layers 9, 11, 16 in the cooling tunnel 18 and before heating the skin of the polypropylene layer 16 via the heating means 19. The solvent is for example MEK (Methyl Ethyl Ketone) deposited by means of a textile strip or by any other means or with another solvent applied in the vapor phase or further a solvent applied in an aqueous medium. In the case when the solvent is applied in an aqueous medium, the surface of the cleaned polypropylene layer 16 is then rinsed with tap water, and then dried by a hot air knife.

Once the elastomer layer 22 has attained the desired thickness, the tube 1 thus coated with the protective casing is then maintained in rotation and in translation and is transferred towards a cooling tunnel 28 where it is sprayed with air and/or water with the purpose of accelerating solidification of the coating.

According to a second embodiment of the invention, illustrated in FIG. 3, the coating of the tube 1 according to the invention further comprises, above the elastomer layer 22, a second polypropylene layer 30 formed with at least one polypropylene strip 31. In this second embodiment, the epoxy layer 9, the adhesive layer 11, the first polypropylene layer 16 and the elastomer layer 22 are successively positioned on the tube 1 below the second polypropylene layer 30 and have the same characteristics as in the first embodiment.

The second polypropylene layer 30 has a thickness preferably comprised between 1 and 6 mm.

The installation allowing application of the method resulting in the tube 1 including the coating according to the second embodiment, is illustrated in FIG. 4. In order to form the coating according to the second embodiment on the tube 1, the steps of the method according to the first embodiment of the invention are reproduced until the elastomer layer 22 has been formed.

After formation of the elastomer layer 22, the tube 1 coated with the already formed layers 9, 11, 16, 22 is passed into the cooling tunnel 28 until a temperature of the tube 1 of the order of 80° C. is attained.

The surface of the elastomer layer 22 may then be cleaned with a solvent in order to degrease it and remove all traces of contaminants or plasticizers. The solvent is for example MEK (Methyl Ethyl Ketone) deposited by means of a textile strip or by any other means or with another solvent applied in a vapor phase or further a solvent applied in an aqueous medium. In the case when the solvent is applied in an aqueous medium, the surface of the cleaned elastomer layer 22 is then rinsed with tap water and then dried by a hot air knife.

Next, the skin of the elastomer layer 22 is heated at the surface via a suitable heating means 29, for example an infrared radiant heater, until a skin temperature of the elastomer layer 22 of at least 110° C. is attained.

At least one polypropylene strip 31 in paste form is then wound onto the elastomer layer 22 in order to form the second polypropylene layer 30 by means of an extrusion machine 32.

Several extrusion machines 32 may be positioned side by side in order to deposit several polypropylene strips 31 on each other in order to form the second polypropylene layer 30.

The tube 1 thus coated with the layers 9, 11, 16, 22, 30 is transferred towards a cooling tunnel 33 where it is sprayed with air and/or water with the purpose of accelerating the solidification of the coating.

Said at least one polypropylene strip 31 may be applied on the elastomer layer 22 by lateral extrusion relatively to the displacement direction of the tube 1, by longitudinal extrusion or by coextrusion.

The thickness of the second polypropylene layer 30 is preferably comprised between 1 and 6 mm.

This second embodiment has the advantage of improving the indentation resistance of the coating according to the invention, since polypropylene is a harder material than the elastomer.

Moreover, the last applied polypropylene layer 30, because of the hydrophobicity of the polypropylene, which has a water absorption coefficient of the order of 0.1%, plays a role of a barrier to seawater, which gives the possibility of avoiding diffusion of water into the elastomer layer 22 and therefore the hydrolysis phenomena which may lead to a reduction in the insulating properties of the coating.

According to a third embodiment of the invention, illustrated in FIG. 5, the coating of the tube 1 according to the invention further comprises, above the second polypropylene layer 30, a second elastomer layer 35, formed with at least one elastomer strip 36. In this third embodiment, the epoxy layer 9, the adhesive layer 11, the first polypropylene layer 16, the elastomer layer 22 and the second polypropylene layer 30 are successively positioned on the tube 1 below the second elastomer layer 35 and have the same characteristics as in the first and second embodiments.

The second elastomer layer 35 has a thickness preferably of the order of 1 mm.

The installation allowing application of the method resulting in the tube 1 including the coating according to the third embodiment, is illustrated in FIG. 6.

In order to form on the tube 1 the coating according to the third embodiment, the steps of the method according to the second embodiment of the invention are reproduced, until formation of the polypropylene layer 30.

After forming this second polypropylene layer 30, the tube 1 coated with the already formed layers 9, 11, 16, 22, 30 is passed into the cooling tunnel 33 until a temperature of the tube 1 of the order of 80° C. is attained.

The surface of the second polypropylene layer 30 may then be cleaned with a solvent, in order to degrease it and remove any traces of contaminants or plasticizers. The solvent is for example MEK (Methyl Ethyl Ketone) deposited by means of a textile strip or by any other means or with another solvent applied in a vapor phase or further a solvent applied in an aqueous medium. In the case when the solvent is applied in an aqueous medium, the cleaned surface of the polypropylene layer 30 is then rinsed with tap water, and then dried by a hot air knife.

Next, the skin of the second polypropylene layer 30 is heated at the surface via a suitable heating means 37, for example an infrared radiant heater, until a skin temperature of the second polypropylene layer 30 of at least 110° C. is attained.

At least one elastomer strip 36 in paste form is then wound onto the second polypropylene layer 30 by means of an extrusion machine 38 in order to form a second elastomer layer 35. At the outlet of the extrusion machine 38, the temperature of the elastomer strip 36 is comprised between 140° C. and 230° C. and preferably between 180° C. and 200° C.

In order to form the elastomer layer 35, consisting of several elastomer strips 36, for each new elastomer strip 36 to be applied, the tube 1 coated with the already formed layers 9, 11, 16, 22, 30 and with the already deposited elastomer strips 36 is first cooled by having it pass into a cooling tunnel 39, where it is sprayed with water and/or air until a temperature of the tube 1 of the order of 80° C. is attained.

The skin of the last applied elastomer strip 36 on the tube 1 is then heated via a suitable heating means 41, for example by a means of an infrared radiant heater, until a skin temperature of at least 110° C. is attained.

An elastomer strip 36 in paste form is then wound onto the last elastomer strip 36 applied by means of an extrusion machine 43. During the winding of the strip 36, in order to allow the elastomer to adhere to itself, the elastomer strip 36 is subject to pressure of about 3 to 4 bars via a pressure application means of a known type, for example by means of a roller in silicone of shore A hardness 23.

This succession of operations is repeated until a second elastomer layer 35 is obtained with the desired thickness. For this, as many blocks consisting of a cooling tunnel 39, of a suitable heating means 41, for example an infrared radiant heater, of an extrusion machine 43 and of a pressure application means of a known type as there are elastomer strips 36 which are desirably deposited for forming a second elastomer layer 35 with the desired thickness, are placed side by side.

A thickness of the second elastomer layer 35 of the order of 1 mm may thereby be obtained.

Next, the tube thereby coated with the layers 9, 11, 16, 22, 30, 35 is transferred towards a coiling tunnel 47 where it is sprayed with air and/or water with the purpose of accelerating solidification of the coating.

Said at least one elastomer strip 36 may be applied onto the second polypropylene layer 30 by lateral extrusion relatively to the displacement direction of the tube 1, by longitudinal extrusion or by coextrusion.

This third embodiment has the advantage, in addition to the advantages exhibited by the first two embodiments, of making the laying of tubes provided with their protective coating secure in deep sea. Indeed, the elastomer has a friction coefficient about ten times greater than that of polypropylene, which allows reduction in the risks of the tube sliding out of the laying structures and therefore a reduction in the risks of losing the tube.

In all the embodiments, the application of the elastomer in successive strips is advantageous, since the insulator may be cooled more easily, which allows the application of a larger total elastomer thickness, since it is difficult to support a tube covered with a thick layer of hot material in paste form without there being any deformation, collapse or ovalization of the layer.

Surprisingly, it was noticed that if different elastomer strips are simply successively wound onto each other, the latter do not adhere to each other. The method consisting of cooling the tube coated with the already formed layers, and then of exclusively heating the skin of the last applied elastomer strip, before applying a new elastomer strip gives the possibility of finding a remedy to this problem and resulting in a homogeneous layer without any delamination.

1. A method for producing a protective coating on a tube (1) notably on a pipeline tube which may be immersed, comprising the steps of:
displacing the tube (1) in a longitudinal translational movement and simultaneously driving said tube (1) in rotation,
heating the tube (1) to a temperature comprised between 160° C. and 230° C. and preferably between 180° C. and 220° C.,
forming from an epoxy powder an epoxy layer (9) on the outer surface of the tube (1),
winding at least one adhesive strip (12) in paste form onto the epoxy layer (9) in order to form an adhesive layer (11),
winding at least one polypropylene strip (17) in paste form onto said adhesive layer (11) in order to form a first polypropylene layer (16),
characterized in that it also comprises steps consisting of:
cooling the thereby obtained assembly down to a temperature of the order of 80° C.,
heating the skin of said first polypropylene layer (16) up to a temperature of a least 110° C., and
winding at least one strip of a heat insulating and incompressible elastomer (23) in paste form in order to form a first elastomer layer (22).

2. The method according to claim 1, characterized in that after having formed said first elastomer layer (22),
the obtained assembly is cooled down to a temperature of the order of 80° C.,
the skin of the first applied elastomer layer (22) is heated up to a temperature of at least 110° C., and
at least one polypropylene strip (31) in paste form is deposited on said first elastomer layer (22) in order to form a second polypropylene layer (30).

3. The method according to claim 2, characterized in that after having formed the second polypropylene layer (30),
the obtained assembly is cooled down to a temperature of the order of 80° C.,
the skin of the second polypropylene layer (30) is heated up to a temperature of at least 110° C., and
at least one strip (36) of said elastomer in paste form is deposited on said second polypropylene layer (30) in order to form a second elastomer layer (35).

4. The method according to claim 1, characterized in that said elastomer has a heat conductivity below 0.15 W·m⁻¹·K⁻¹.

5. The method according to claim 1, characterized in that said elastomer comprises at least one crosslinkable elastomer selected from butyl rubber, halobutyls and brominated copolymers of isobutylene and paramethylstyrene and at least one non-crosslinkable elastomer with low heat conductivity.

6. The method according to claim 1, characterized in that the epoxy powder is deposited by electrostatic spraying and said powder is agglomerated by melting.

7. The method according to claim 1, characterized in that the epoxy layer (9) has a thickness comprised between 10 and 800 micrometers, and preferably between 150 and 300 micrometers.

8. The method according to claim 1, characterized in that the adhesive layer (11) has a thickness comprised between 10 and 1 000 micrometers, and preferably comprised between 300 and 600 micrometers.

9. The method according to claim 1, characterized in that said strips (23), (36) of said first or second elastomer layers (22, 35) or said strips (17, 31) of said first or second polypropylene layer (16, 30) or said strips (12) of said adhesive layer (11) are obtained by lateral extrusion relatively to the displacement direction of the tube (1).

10. The method according to claim 1, characterized in that said strips (23, 36) of said first or second elastomer layers (22, 35) or said strips (17, 31) of said first or second polypropylene layers (16, 30) or said strips (12) of said adhesive layer (11) are obtained by longitudinal extrusion relatively to the displacement direction of the tube (1).

11. The method according to claim 1, characterized in that said strips (23, 36) of said first or second elastomer layers (22, 35) or said strips (17, 31) of said first or second polypropylene layer (16, 30) or said strips (12) of said adhesive layer (11) are obtained by coextrusion.

12. The method according to claim 1, characterized in that said strips (23, 36) of said first or second elastomer layers (22, 35) are set under pressure by means of a pressure roller.

13. The method according to claim 1, characterized in that each of said strips (23) of said first elastomer layer (22) have a thickness comprised between 2 and 30 mm.

14. The method according to claim 1, characterized in that said strips (23, 36) of said first and second elastomer layers (22, 35) are extruded at a temperature comprised between 140° C. and 230° C. and preferably between 180° C. and 200° C.

15. A tube including a coating obtained by the method according to claim 1, characterized in that it successively includes an epoxy layer (9), an adhesive layer (11), a first polypropylene layer (16) and a first elastomer layer (22).

16. The tube according to claim 15, characterized in that it further includes a second polypropylene layer (30) above the first elastomer layer (22).

17. The tube according to claim 16, characterizing that it further includes a second elastomer layer (35) above the second polypropylene layer (30).

18. The method according to claim 2, characterized in that said elastomer has a heat conductivity below 0.15 W·m⁻¹·K⁻¹.

19. The method according to claim 3, characterized in that said elastomer has a heat conductivity below 0.15 W·m⁻¹·K⁻¹.

20. The method according to claim 2, characterized in that said elastomer comprises at least one crosslinkable elastomer selected from butyl rubber, halobutyls and brominated copolymers of isobutylene and paramethylstyrene and at least one non-crosslinkable elastomer with low heat conductivity.
